(19) United States
(12) Patent Application Publication
(10) Pub. No.: US 2026/0267076 A1
(43) Pub. Date: Sep. 10, 2026

(54) CONNECTOR

(71) Applicant: Sumitomo Electric Optifrontier Co., Ltd., Yokohama-shi (JP)

(72) Inventors: Ryo ITO, Kanagawa (JP); Masahiro Shibata, Kanagawa (JP); Yohei Aoshima, Kanagawa (JP)

(73) Assignee: Sumitomo Electric Optifrontier Co., Ltd., Yokohama-shi (JP)

(21) Appl. No.: 19/538,343

(22) Filed: Feb. 12, 2026

(30) Foreign Application Priority Data
Mar. 10, 2025 (JP) 2025-037504

(51) Int. Cl. G02B 6/38

(52) U.S. Cl. CPC G02B 6/3825; G02B 6/38875; G02B 6/3893; G02B 6/3895; G02B 6/3897

(57) ABSTRACT

A connector is attachably and detachably connected to an adapter. The connector includes a housing, a tab connected to the housing, and a boot rotatable with respect to the housing and configured to move with the tab. The housing includes a protrusion. The boot has a hook portion engageable with the protrusion. The tab is provided with an opening into which the protrusion and the hook portion are inserted. The hook portion is configured to be engaged with the protrusion to enter into a locked state by the boot being rotated in a first rotational direction about an axis extending along the first direction with respect to the housing. In the locked state, the boot is configured to be restricted from movement along the first direction with respect to the housing. The hook portion protrudes from the opening and is visible from a plurality of directions.

### CROSS REFERENCE TO RELATED APPLICATIONS

This application claims priority based on Japanese Patent Application No. 2025-037504 filed on Mar. 10, 2025, and the entire contents of the Japanese patent application are incorporated herein by reference.

### TECHNICAL FIELD

The present disclosure relates to a connector.

### BACKGROUND

Patent literature 1 (U.S. Patent Application Publication No. 2023/0221500) describes a connector that is attachably and detachably connected to an adapter. The connector includes an optical fiber connector portion having a latch and a boot connected to the rear of the optical fiber connector portion. The connector is inserted into and removed from the adapter along the direction in which the connector extends. In this connector, it is possible to switch between an unlocked state in which the boot is movable rearward with respect to the optical fiber connector portion and a locked state in which the boot is not movable rearward with respect to the optical fiber connector portion. In the unlocked state, when the boot moves rearward, the connector is detached from the adapter. The locked state and the unlocked state may be switched by the boot being rotated with respect to the optical fiber connector portion about the axis of the boot.

In this connector, a cylindrical boot receiver is provided at a rear end portion of the optical fiber connector portion, and a holder mount into which the boot receiver is inserted is provided at a front end portion of the boot. A cover is fitted to the holder mount. The outer peripheral surface of the cover is provided with an opening, and the holder mount has a protrusion that enters the opening.

### SUMMARY OF INVENTION

A connector according to the present disclosure is a connector attachably and detachably connected to an adapter. The connector includes a housing having a latch configured to be locked onto the adapter, a tab connected to the housing and covering at least a portion of the latch, and a boot rotatable with respect to the housing and configured to move with the tab. The tab is configured to release the latch from being locked onto the adapter by moving in a first direction in which the connector is detached from the adapter. The housing includes a protrusion. The boot has a hook portion engageable with the protrusion. The tab is provided with an opening into which the protrusion and the hook portion are inserted. The hook portion is configured to be engaged with the protrusion to enter into a locked state by the boot being rotated in a first rotational direction about an axis extending along the first direction with respect to the housing. In the locked state, the boot is configured to be restricted from movement along the first direction with respect to the housing. The hook portion protrudes from the opening and is visible from a plurality of directions.

### BRIEF DESCRIPTION OF THE DRAWINGS

FIG. 1 is a perspective view illustrating a connector as an example.

FIG. 2 is a side view illustrating the connector of FIG. 1.

FIG. 3 is an exploded perspective view illustrating the connector of FIG. 1.

FIG. 4A is a perspective view illustrating a housing with an elastic member connected thereto.

FIG. 4B is a partially enlarged view of a portion of the housing of FIG. 4A.

FIG. 5A is a perspective view illustrating a tab.

FIG. 5B is a perspective view of the tab as viewed from a direction different from that of FIG. 5A.

FIG. 6A is a perspective view illustrating a boot.

FIG. 6B is a perspective view of the boot as viewed from a direction different from that of FIG. 6A.

FIG. 7 is a cross-sectional view illustrating the connector in a locked state taken along line VII-VII of FIG. 2.

FIG. 8 is a cross-sectional view illustrating the connector in an unlocked state taken along line VII-VII of FIG. 2.

FIG. 9 is a perspective view illustrating a boot according to a modification.

FIG. 10 is a rear view illustrating the boot according to the modification.

### DETAILED DESCRIPTION

Incidentally, there are cases where a large number of connectors are arranged at high density. In such a case, it may be difficult to visually recognize the connector connected to the adapter. When it is difficult to visually recognize the connector, it may not be easy to recognize whether the connector is in the locked state or the unlocked state. When the boot is rotated when the connector is in the locked state, the boot may be damaged. Thus, it is required to easily recognize whether the connector is in the locked state.

An object of the present disclosure is to provide a connector that is easily recognized whether the connector is in a locked state.

According to the present disclosure, it is possible to easily recognize whether or not the connector is in the locked state.

### Description of Embodiments of Present Disclosure

First, the contents of the embodiments of the present disclosure will be listed and described.

(1) A connector according to an embodiment is a connector attachably and detachably connected to an adapter. The connector includes a housing having a latch configured to be locked onto the adapter, a tab connected to the housing and covering at least a portion of the latch, and a boot rotatable with respect to the housing and configured to move with the tab. The tab is configured to release the latch from being locked onto the adapter by moving in a first direction in which the connector is detached from the adapter. The housing includes a protrusion. The boot has a hook portion engageable with the protrusion. The tab is provided with an opening into which the protrusion and the hook portion are inserted. The hook portion is configured to be engaged with the protrusion to enter into a locked state by the boot being rotated in a first rotational direction about an axis extending along the first direction with respect to the housing. In the locked state, the boot is configured to be restricted from movement along the first direction with respect to the housing. The hook portion protrudes from the opening and is visible from a plurality of directions.

In this connector, the housing has a latch, and the tab covers at least a part of the latch. The boot is rotatable with respect to the housing and moves with the tab. The tab moves in the first direction, and thus the latch is released from being locked onto the adapter. The housing has a protrusion, and the boot has a hook portion engageable with the protrusion. The tab has an opening into which the protrusion and the hook portion are inserted, and the hook portion rotates in a first rotational direction with respect to the housing. In this connector, the hook portion rotates in the first rotational direction, thereby entering into a locked state in which movement of the boot with respect to the housing is restricted. The hook portion protrudes from the opening and is visible from a plurality of directions. Since the hook portion to enter into the locked state protrudes from the opening and is visible from the plurality of directions, the position of the hook portion can be easily recognized. Thus, it is possible to easily recognize whether the connector is in the locked state by observing the position of the hook portion being rotated in the first rotational direction.

(2) In the above (1), the hook portion may be configured to be disengaged from the protrusion to enter into an unlocked state by the boot being rotated in a second rotational direction opposite to the first rotational direction with respect to the housing. In the unlocked state, the boot may be movable along the first direction with respect to the housing. In this case, the state can be entered into the unlocked state by the boot being rotated in the second rotational direction with respect to the housing. In the unlocked state, the boot can move along the first direction with respect to the housing. Thus, the connector can be detached from the adapter.

(3) In the above (1) or (2), the boot may have an identification portion indicating a position of the hook portion. In this case, the position of the hook portion can be easily recognized by visually recognizing the identification portion, and thus, it can be more easily recognized whether or not the connector is in the locked state.

(4) In the above (3), the identification portion may be a marker located on an outer surface of the boot at a position away from the hook portion in the first direction. The marker may have a color different from a color of a portion of the outer surface of the boot adjacent to the marker. In this case, the color of the marker on the outer surface of the boot is different from the color of the portion adjacent to the marker, so that the identification portion can be more easily visually recognized.

(5) In the above (3), the identification portion may be a boot protrusion protruding from an outer peripheral surface of the boot at a portion away from the hook portion in the first direction. In this case, the boot protrusion protrudes from the outer peripheral surface of the boot at a position away from the hook portion, and thus the identification portion can be more easily visually recognized.

(6) In any one of (1) to (5), a direction from the axis toward the opening may be the same as a direction from the axis toward the latch. In this case, the direction of the connector for confirming the connection between the latch and the adapter is the same as the direction of the connector for confirming the engagement between the hook portion and the protrusion. Thus, the connection and the engagement are easily performed.

(7) In any one of the above (1) to (6), the connector may be an LC connector that further includes a plurality of ferrules, each of the plurality of ferrules holding an optical fiber.

### Details of Embodiments of Present Disclosure

Hereinafter, a specific example of a connector according to an embodiment will be described with reference to the drawings. The present disclosure is not limited to these examples, and is intended to include all modifications within the scope of the claims and the scope of equivalents of the claims. In the description of the drawings, the same or corresponding elements are denoted by the same reference signs, and redundant description will be omitted as appropriate. In the drawings, some parts may be simplified or exaggerated for easy understanding, and the dimensional ratios and the like are not limited to those shown in the drawings.

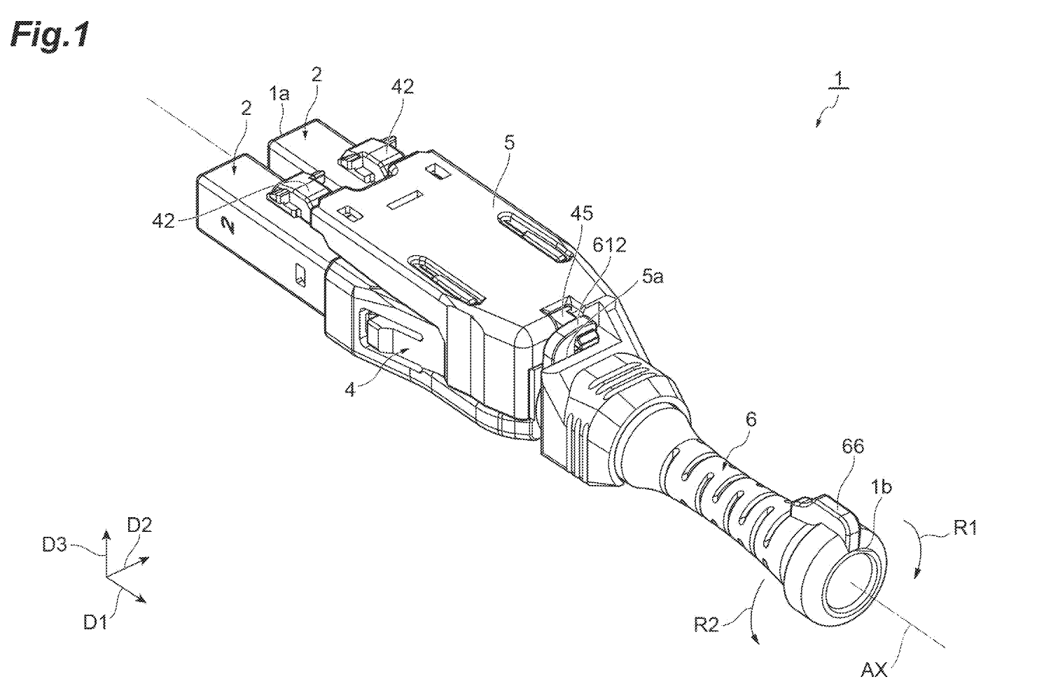

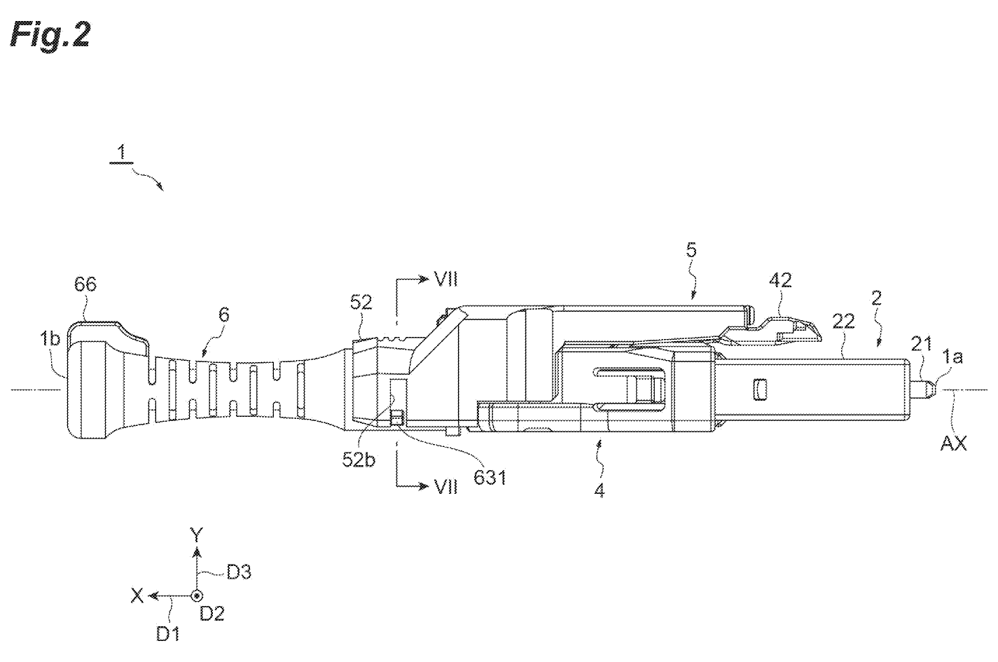

FIG. 1 is a perspective view illustrating a connector 1 as an example. FIG. 2 is a side view illustrating the connector 1 of FIG. 1. The connector 1 is attachably and detachably connected to an adapter provided outside the connector 1. The connector 1 is inserted into and removed from the adapter along a first direction D1. The connector 1 is removed from the adapter along the first direction D1. The first direction D1 is a direction in which the connector 1 is detached from the adapter. The connector 1 is inserted into the adapter along a direction opposite to the first direction D1. The connector 1 has an axis AX extending along the first direction D1.

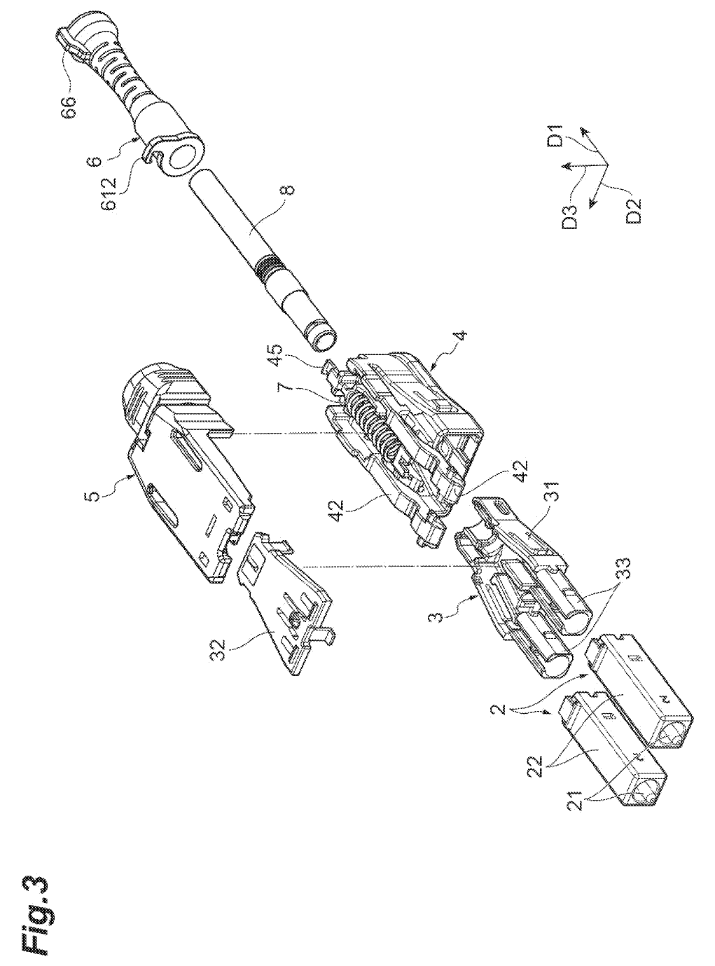

The connector 1 extends in the first direction D1. The connector 1 has a front end 1a and a rear end 1b located opposite to the front end 1a in the first direction D1. In the embodiment, a direction in which the rear end 1b is located with respect to the front end 1a may be referred to as "rear", "rear side", or "rearward", and an opposite direction thereof may be referred to as "front", "front side", or "frontward". A direction from the front end 1a to the rear end 1b is the first direction D1. The connector 1 holds an optical cable. The optical cable is inserted from the rear end 1b of the connector 1. The optical cable has a plurality of optical fibers. The plurality of optical fibers are held by a pair of ferrules 21 (see FIG. 3) in a state where the coating resin is removed.

The connector 1 is, for example, a duplex LC connector, and is an uniboot connector. However, the connector may be a multiple LC connector having three or more connections. In this manner, the type of the connector is not particularly limited.

FIG. 3 is an exploded perspective view illustrating the connector 1 of FIG. 1. As illustrated in FIGS. 1, 2 and 3, the connector 1 includes a pair of front housings 2, an inner housing 3, a housing 4, a tab 5, a boot 6, an elastic member 7 and a cable holding member 8. The front housing 2 is disposed at an end portion of the front side (front end) of the connector 1. The front housing 2 has the ferrule 21 holding an optical fiber and a body portion 22 accommodating the ferrule 21. The body portion 22 has a rectangular parallelepiped shape. An opening is formed at the front end of the body portion 22. The front end of the ferrule 21 is exposed from the opening of the front end of the body portion 22. The body portion 22 includes a synthetic resin.

The inner housing 3 is a housing having a space formed therein accommodating an optical fiber. The inner housing 3 has a body portion 31 through which the optical fiber is inserted, and a lid portion 32 forming an upper surface of the inner housing 3. The lid portion 32 is connected to the body portion 31. An end portion of the rear side (rear end) of the body portion 31 is open. The length of the body portion 31 in a second direction D2 increases toward the direction opposite to the first direction D1. The second direction D2 is a direction intersecting (for example, orthogonal to) the first direction D1.

One path through which the optical fiber is inserted is provided at the rear end of the body portion 31, and the path is branched into two branch paths inside the body portion 31. The optical fiber is branched into two branch paths. The body portion 31 has a pair of connection portions 33 to which the front housing 2 is connected. The connection portion 33 is located at the front end of the body portion 31. Each of the two branch paths is connected to each of the pair of connection portions 33. The inner housing 3 includes a synthetic resin.

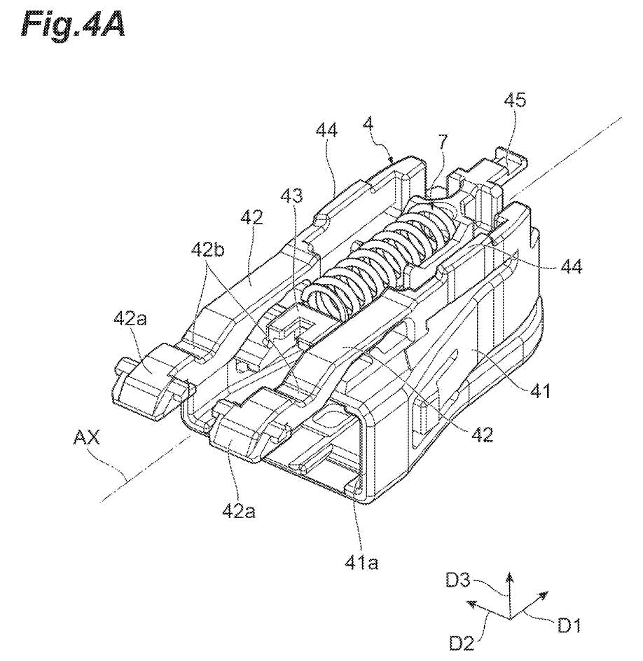

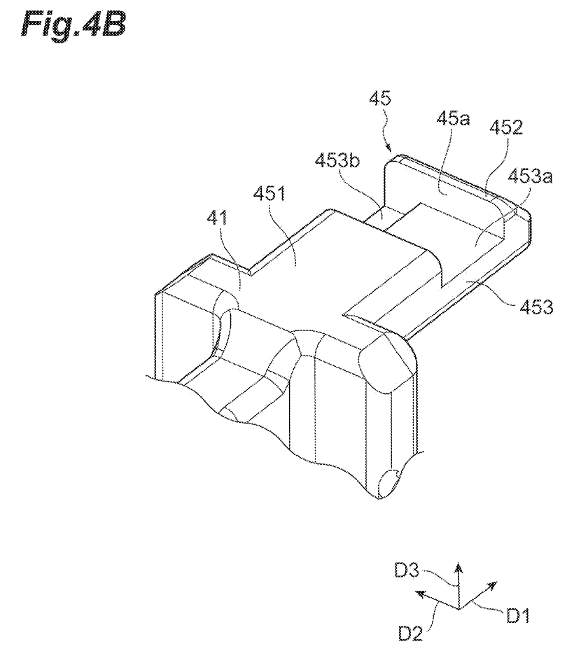

The housing 4 and the elastic member 7 will be described with reference to FIG. 4A. FIG. 4A is a perspective view illustrating the housing 4 to which the elastic member 7 is connected. The housing 4 is, for example, an outer housing accommodating the inner housing 3 therein. The housing 4 has a body portion 41 accommodating the inner housing 3. The body portion 41 has an opening 41a at the front end. The inner housing 3 is accommodated in the body portion 41 through the opening 41a.

The housing 4 has a pair of latches 42. The latch 42 is arranged with the body portion 41 along a third direction D3. The third direction D3 is a direction intersecting (for example, orthogonal to) both the first direction D1 and the second direction D2. In the embodiment, a direction in which the latch 42 is located with respect to the body portion 41 may be referred to as "up", "upper side", or "upward", and an opposite direction thereof may be referred to as "down", "lower side", or "downward". The latch 42 extends in the first direction D1. The rear end of the latch 42 is connected to the body portion 41. The latch 42 extends from the body portion 41 in a direction opposite to the first direction D1.

The latch 42 is a portion configured to be locked onto the adapter. The latch 42 has a projecting portion 42a and a recessed portion 42b, and the projecting portion 42a is locked onto the adapter. The projecting portion 42a is located frontward the front end of the body portion 41. The recessed portion 42b is a portion that is recessed with respect to the projecting portion 42a. The recessed portion 42b is located rearward the projecting portion 42a.

The housing 4 has a restricting portion 43 restricting the movement of the tab 5 with respect to the housing 4. The restricting portion 43 is located between the pair of latches 42. The restricting portion 43 has a U-shape with an open front portion in a plan view. The elastic member 7 is disposed between the pair of latches 42. The housing 4 has a pair of projecting portions 44 located rearward the pair of latches 42. The projecting portion 44 protrudes upwardly. The projecting portion 44 extends in the first direction D1. The elastic member 7 is located rearward the restricting portion 43 and between the pair of projecting portions 44.

The housing 4 has a protrusion 45. Referring to FIG. 4B, the protrusion 45 will be described. FIG. 4B is a partially enlarged view of a portion of the housing 4 of FIG. 4A. The protrusion 45 extends rearward from the rear end of the body portion 41. The protrusion 45 has a rectangular shape in a plan view. The protrusion 45 has a front end portion 451, a rear end portion 452, and a bottom portion 453 located between the front end portion 451 and the rear end portion 452. The front end portion 451, the bottom portion 453, and the rear end portion 452 are arranged along the first direction D1. The front end portion 451 is connected to the body portion 41. The bottom portion 453 has a thickness less than that of the front end portion 451 and less than that of the rear end portion 452. The front end portion 451, the bottom portion 453, and the rear end portion 452 form a groove 45a.

The bottom portion 453 has a first surface 453a facing upward and a second surface 453b facing upward. The first surface 453a is arranged with the second surface 453b along the second direction D2. The length of the first surface 453a in the second direction D2 is greater than the length of the second surface 453b in the second direction D2. The second surface 453b is located downward the first surface 453a. The depth of the second surface 453b in the groove 45a is greater than the depth of the first surface 453a in the groove 45a.

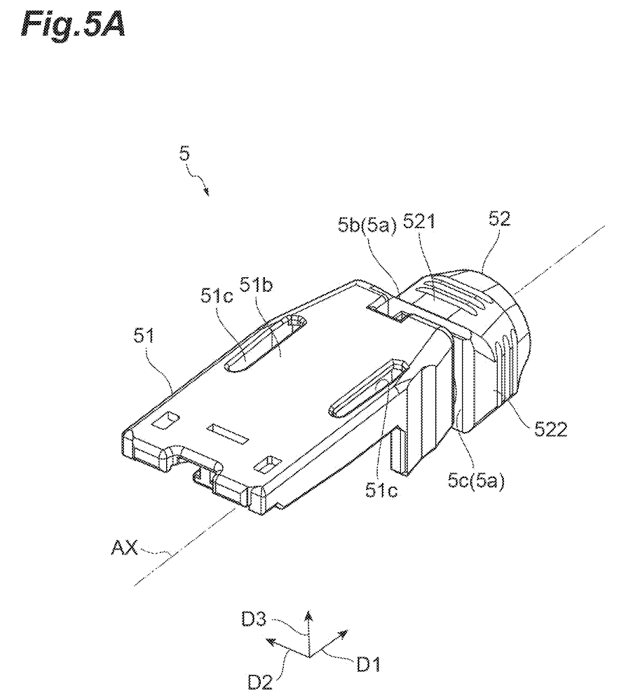

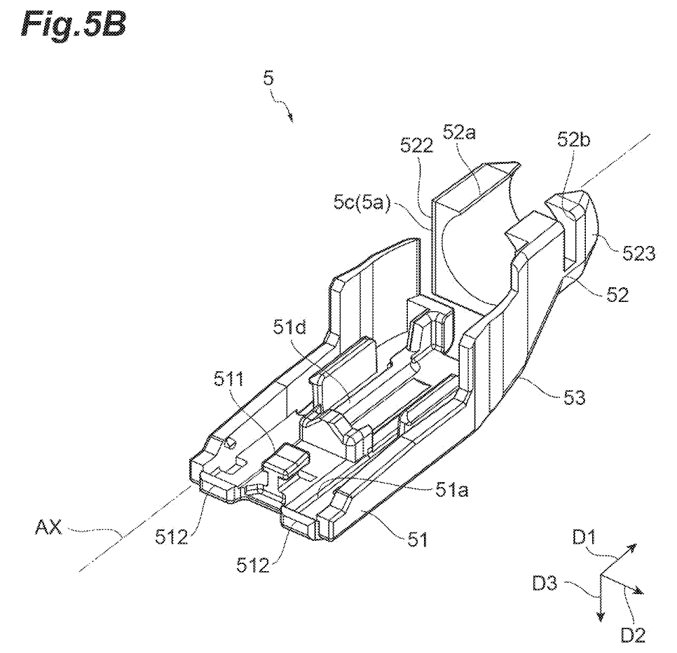

The tab 5 will be described with reference to FIGS. 5A and 5B. FIG. 5A is a perspective view illustrating the tab 5. FIG. 5B is a perspective view of the tab 5 as viewed from a direction different from that of FIG. 5A. The tab 5 is arranged with the housing 4 (see FIG. 1) along the third direction D3. The tab 5 is connected to the housing 4. The tab 5 is movable in the first direction D1 with respect to the housing 4. The tab 5 covers at least a part of the latch 42. The tab 5 includes a cover portion 51, a holding portion 52 located rearward the cover portion 51, and a connection portion 53 connecting the cover portion 51 to the holding portion 52. The cover portion 51 covers a portion other than the projecting portion 42a (see FIG. 4A) of the latch 42. The projecting portion 42a is not covered by the cover portion 51. The cover portion 51 has a rectangular shape in a plan view.

The cover portion 51 has an inner surface 51a facing the body portion 41 (see FIG. 4A) and an outer surface 51b facing away from the inner surface 51a. The cover portion 51 has a projecting portion 511 provided on the inner surface 51a. The projecting portion 511 is arranged with the restricting portion 43 provided in the housing 4 along the first direction D1. The projecting portion 511 is in contact with the restricting portion 43 when the tab 5 moves in the first direction D1 with respect to the housing 4. At this time, the movement of the tab 5 with respect to the housing 4 is restricted.

The cover portion 51 has a pair of slits 51c provided on the outer surface 51b. The slit 51c extends in the first direction D1. The slit 51c penetrates the cover portion 51 in the third direction D3. Each of the pair of projecting portions 44 (see FIG. 4A) are inserted into a corresponding one of the pair of slits 51c. The projecting portion 44 moves along the first direction D1 inside the slit 51c, so that the tab 5 can move by a certain amount with respect to the housing 4.

The cover portion 51 has a disposition portion 51d provided on the inner surface 51a. The elastic member 7 is disposed in the disposition portion 51d. The disposition portion 51d is located rearward the projecting portion 511. The cover portion 51 has a claw portion 512 that enters the recessed portion 42b (see FIG. 4A) of the latch 42. The claw portion 512 is located at the front end of the cover portion 51.

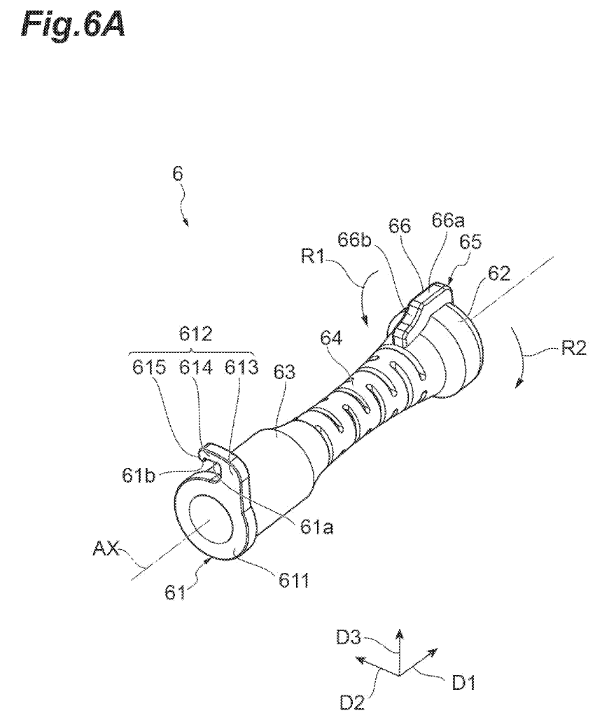

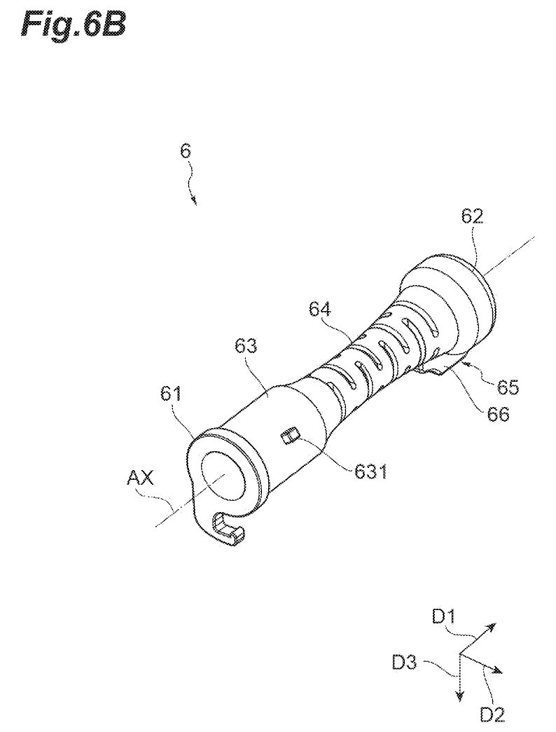

The holding portion 52 holds the boot 6 (see FIG. 3). The holding portion 52 has a cylindrical shape with an open lower portion. The holding portion 52 includes an upper surface portion 521, a first side wall 522 extending downward from the upper surface portion 521, and a second side wall 523 arranged with the first side wall 522 along the second direction D2. A distance from the upper surface of the upper surface portion 521 to the axis AX is smaller than a distance from the outer surface 51b to the axis AX. The holding portion 52 has a gap 52a. The length of the gap 52a in the second direction D2 is smaller than the outer diameter of a connection portion 63 (see FIG. 6A) of the boot 6 to be described later. The inner peripheral surface of the holding portion 52 is cylindrical. The inside diameter of the holding portion 52 is, for example, 6.2 mm.

The holding portion 52 has a cut-out 52b penetrating from the inner peripheral surface of the holding portion 52 to the outer surface of the holding portion 52. The cut-out 52b is formed in the second side wall 523. The cut-out 52b is open downward. The cut-out 52b is in communication with the gap 52a.

The tab 5 has an opening 5a located between the cover portion 51 and the holding portion 52. The connection portion 53 connects the second side wall 523 to the cover portion 51. The connection portion 53 connects an end portion of the upper surface portion 521 in the second direction D2 to the cover portion 51. The end portion is a portion connecting the upper surface portion 521 and the second side wall 523 to each other. The first side wall 522 is not connected to the cover portion 51. The opening 5a is, for example, a gap formed between the cover portion 51 and the holding portion 52.

The opening 5a is open in the third direction D3 and the opposite direction to the second direction D2. The opening 5a has a first portion 5b located between the upper surface portion 521 and the cover portion 51, and a second portion 5c located between the first side wall 522 and the cover portion 51. The opening 5a receives the protrusion 45 (see FIG. 4B). The direction from the axis AX to the opening 5a is the same as the direction from the axis AX to the latch 42. More specifically, the direction from the axis AX toward the first portion 5b is the same as the direction from the axis AX toward the latch 42.

As illustrated in FIGS. 4A and 4B, the mechanism by which the tab 5 releases the latch 42 from being locked onto the adapter will now be described. When the force in the first direction D1 is applied to the tab 5, the tab 5 moves in the first direction D1 with respect to the housing 4. Then, the claw portion 512 moves in the first direction D1 with respect to the recessed portion 42b of the latch 42. When the claw portion 512 moves in the first direction D1 with respect to the recessed portion 42b, the portion of the latch 42 located rearward the recessed portion 42b is pushed down by the claw portion 512. At this time, the projecting portion 42a moves down so as to approach the axis AX. The projecting portion 42a is then disengaged from the adapter. In this manner, the tab 5 moves in the first direction D1, thereby releasing the latch 42 with respect to the adapter. When the force is no longer applied to the tab 5, the elastic member 7 pushes the tab 5 back frontward.

The boot 6 will be described with reference to FIGS. 6A and 6B. FIG. 6A is a perspective view illustrating the boot 6. FIG. 6B is a perspective view of the boot 6 as viewed from a direction different from that of FIG. 6A. The boot 6 is arranged with the housing 4 along the first direction D1. The boot 6 has the axis AX extending along the first direction D1. The boot 6 has a tubular shape (a cylindrical shape as an example). The boot 6 is rotatable about the axis AX with respect to the housing 4. The cable holding member 8 (see FIG. 3) is accommodated in the boot 6. An optical cable is inserted into the cable holding member 8. The cable holding member 8 has a tubular shape.

The boot 6 includes a front end portion 61, a rear end portion 62, the connection portion 63 located between the front end portion 61 and the rear end portion 62, and an extending portion 64 located between the connection portion 63 and the rear end portion 62. The connection portion 63 is held by the holding portion 52 (see FIG. 5B) of the tab 5. The connection portion 63 is inserted into the holding portion 52 through the gap 52a. The outer diameter of the connection portion 63 is substantially the same as the inner diameter of the holding portion 52. The outer diameter of the connection portion 63 is, for example, 6.2 mm. For example, the connection portion 63 is held by the holding portion 52 such that the outer peripheral surface of the connection portion 63 is in close contact with the inner peripheral surface of the holding portion 52. The connection portion 63 has a protrusion 631 protruding from an outer peripheral surface of the connection portion 63. The protrusion 631 extends away from the axis AX. The protrusion 631 enters the cut-out 52b of the holding portion 52.

The extending portion 64 has flexibility. A plurality of grooves are formed on the outer peripheral surface of the extending portion 64. When an external force is applied to the extending portion 64, the extending portion 64 can be bent by the widths of the plurality of grooves in the first direction D1 being widened and the widths being narrowed. The length of the extending portion 64 in the first direction D1 is greater than the length of the connection portion 63 in the first direction D1. The outer diameter of the rear end portion 62 is greater than the outer diameter of the extending portion 64. The outer diameter of the extending portion 64 decreases toward the center of the extending portion 64 in the first direction D1.

The boot 6 has an identification portion 65 indicating a position of a hook portion 612 to be described later. The identification portion 65 is a boot protrusion 66. The boot protrusion 66 is provided at a portion away from the hook portion 612 in the first direction D1. The boot protrusion 66 is formed across the rear end portion 62 and the extending portion 64. The boot protrusion 66 protrudes from the outer peripheral surface of the rear end portion 62 and the outer peripheral surface of the extending portion 64. The boot protrusion 66 has an upper surface 66a and an inclined surface 66b extending frontward and downward from the upper surface 66a.

The front end portion 61 includes a body portion 611 and the hook portion 612. The body portion 611 has an annular shape (as an example, a circular ring shape). The outer diameter of the body portion 611 is greater than the outer diameter of the connection portion 63. The outer diameter of the body portion 611 is greater than the inner diameter of the holding portion 52 (see FIG. 5B) of the tab 5. The outer diameter of the body portion 611 is, for example, 6.8 mm. When the boot 6 moves in the first direction D1, the body portion 611 is caught by the holding portion 52. At this time, the boot 6 moves in the first direction D1 together with the tab 5.

As illustrated in FIGS. 4A and 6A, the position of the hook portion 612 in the first direction D1 is the same as the position of the protrusion 45 in the first direction D1. The opening 5a receives the hook portion 612. The hook portion 612 is engageable with the protrusion 45. The hook portion 612 includes a first portion 613, a second portion 614, and a third portion 615. The first portion 613 is connected to the body portion 611. The first portion 613 extends in a direction away from the axis AX.

The second portion 614 extends from the first portion 613 in a first rotational direction R1 to be described later. The third portion 615 extends from the second portion 614 toward the axis AX. A gap 61a is provided between the second portion 614 and the body portion 611, and a gap 61b is provided between the third portion 615 and the body portion 611.

As illustrated in FIGS. 4B and 6A, in a state where the hook portion 612 is engaged with the protrusion 45, the second portion 614 faces the first surface 453a. In a state where the hook portion 612 is engaged with the protrusion 45, the third portion 615 faces the second surface 453b. The first surface 453a is located in the gap 61a, and the second surface 453b is located in the gap 61b.

In a state where the hook portion 612 is engaged with the protrusion 45, when the boot 6 moves in the first direction D1, the second portion 614 of the hook portion 612 is caught by the rear end portion 452 of the protrusion 45. Thus, the movement of the boot 6 with respect to the housing 4 along the first direction D1 is restricted. The hook portion 612 is disengaged from the protrusion 45 when the boot 6 is rotated in a second rotational direction R2 about the axis AX with respect to the housing 4. The second rotational direction R2 is a counterclockwise direction when the connector 1 is viewed from the rear. In a state where the hook portion 612 is disengaged from the protrusion 45, the boot 6 is movable along the first direction D1 with respect to the housing 4. The hook portion 612 is engaged with the protrusion 45 by the boot 6 being rotated in the first rotational direction R1 about the axis AX with respect to the housing 4. The first rotational direction R1 is a clockwise direction when the connector 1 is viewed from the rear.

When the boot 6 is rotated in the first rotational direction R1 with respect to the housing 4 about the axis AX, the connector 1 enters into a locked state S1 to be described later. When the boot 6 is rotated in the second rotational direction R2 with respect to the housing 4 about the axis AX, the connector 1 enters into an unlocked state S2 to be described later.

A method of assembling the connector 1 will be described. First, the inner housing 3 is assembled by connecting the lid portion 32 to the body portion 31 illustrated in FIG. 3. Subsequently, the front housing 2 is connected to the connection portion 33. The inner housing 3 to which the front housing 2 is connected is accommodated in the body portion 41 of the housing 4. Subsequently, the elastic member 7 is disposed in the body portion 41. The cable holding member 8 is accommodated in the boot 6. The cable holding member 8 is inserted into the inner housing 3 from the rear. Then, the cover portion 51 of the tab 5 is connected to the housing 4, and the holding portion 52 of the tab 5 is connected to the boot 6. Thus, the connector 1 is assembled. An optical cable is inserted into the connector 1 in the process of assembling the connector 1.

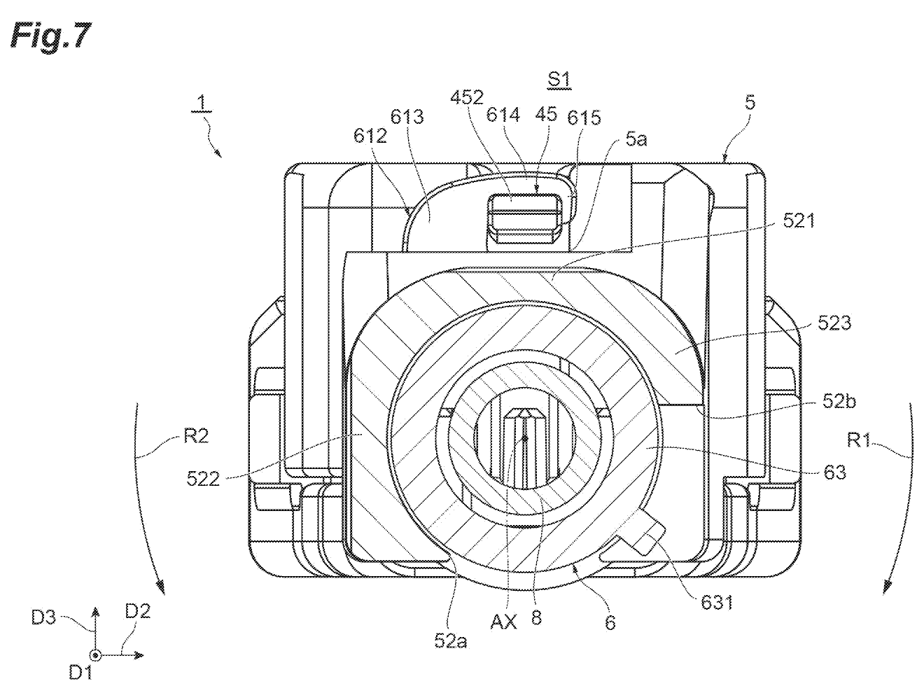

The position of the hook portion 612 and the position of the protrusion 631 in the locked state S1 will be described with reference to FIG. 7. FIG. 7 is a cross-sectional view illustrating the connector 1 in the locked state S1 taken along line VII-VII of FIG. 2. As illustrated in FIG. 7, in the locked state S1, the hook portion 612 protrudes from the opening 5a. A distance from the second portion 614 to the axis AX is greater than a distance from the upper surface of the upper surface portion 521 to the axis AX. When viewed along the direction opposite to the first direction D1, it is possible to visually recognize that the hook portion 612 is engaged with the protrusion 45. The engagement of the hook portion 612 with the protrusion 45 is visible from the direction opposite to the first direction D1, the second direction D2, and the direction opposite to the third direction D3. Thus, it is possible to easily recognize that the connector 1 is in the locked state S1. The position of the protrusion 631 in the third direction D3 is substantially the same as the position of the gap 52a in the third direction D3.

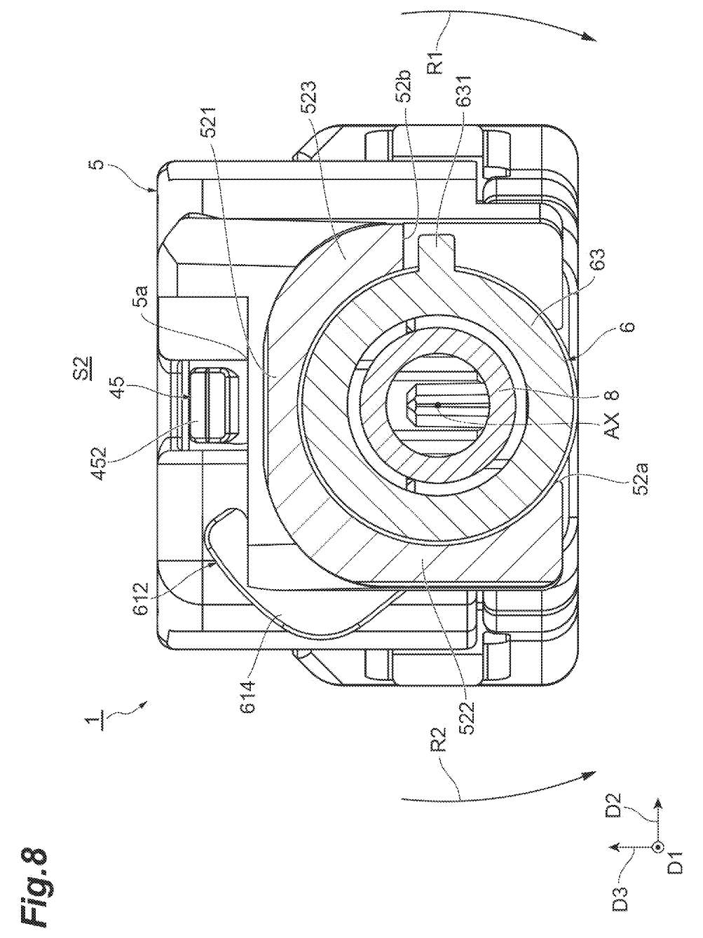

The position of the hook portion 612 and the position of the protrusion 631 in the unlocked state S2 will be described with reference to FIG. 8. FIG. 8 is a cross-sectional view illustrating the connector 1 in the unlocked state S2 taken along line VII-VII of FIG. 2. As illustrated in FIG. 8, in the unlocked state S2, the hook portion 612 protrudes from the opening 5a. A distance from the second portion 614 to the axis AX is greater than a distance from the outer surface of the second side wall 523 to the axis AX. The hook portion 612 being disengaged from the protrusion 45 is visible from the direction opposite to the first direction D1, the second direction D2, and the direction opposite to the third direction D3. Thus, it is possible to easily recognize that the connector 1 is in the unlocked state S2. The position of the protrusion 631 in the third direction D3 is, for example, substantially the same as the position of the upper end of the cut-out 52b.

As illustrated in FIG. 1, in the connector 1, whether or not the hook portion 612 is engaged with the protrusion 45 can be visually recognized by viewing the opening 5a from the direction opposite to the first direction D1, the second direction D2, and the direction opposite to the third direction D3. In the connector 1, the hook portion 612 is visible from a plurality of directions. That is, it is possible to recognize from a plurality of directions that the connector 1 is in the locked state S1 and that the connector 1 is in the unlocked state S2.

As described above, in the connector 1, the housing 4 has the latch 42, and the tab 5 covers at least a part of the latch 42. The boot 6 is rotatable with respect to the housing 4 and moves together with the tab 5. When the tab 5 moves in the first direction D1, the latch 42 is released from the adapter. The housing 4 has the protrusion 45, and the boot 6 has the hook portion 612 engageable with the protrusion 45. The tab 5 has the opening 5a into which the protrusion 45 and the hook portion 612 are inserted, and the hook portion 612 rotates in the first rotational direction R1 with respect to the housing 4. In the connector 1, the hook portion 612 rotates in the first rotational direction R1, and thus the connector 1 enters into the locked state S1 in which the movement of the boot 6 with respect to the housing 4 is restricted.

The hook portion 612 protrudes from the opening 5a and is visible from a plurality of directions. Since the hook portion 612 to enter into the locked state S1 protrudes from the opening 5a and is visible from a plurality of directions, the position of the hook portion 612 can be easily recognized. Thus, it is possible to easily recognize whether the connector 1 is in the locked state by viewing the position of the hook portion 612 being rotated in the first rotational direction R1.

The hook portion 612 is disengaged from the protrusion 45 and enters into the unlocked state S2 by the boot 6 being rotated in the second rotational direction R2, which is opposite to the first rotational direction R1, with respect to the housing 4. In the unlocked state S2, the boot 6 is movable with respect to the housing 4 along the first direction D1. The boot 6 is rotated in the second rotational direction R2 with respect to the housing 4, and thus, the state can be entered into the unlocked state S2. In the unlocked state S2, the boot 6 is movable along the first direction D1 with respect to the housing 4. Thus, the connector 1 can be detached from the adapter.

The boot 6 has the identification portion 65 indicating the position of the hook portion 612. Since the position of the hook portion 612 can be easily recognized by visually recognizing the identification portion 65, it can be more easily recognized whether or not the connector 1 is in the locked state S1.

The identification portion 65 is the boot protrusion 66 protruding from the outer peripheral surface of the boot 6 at a portion away from the hook portion 612 in the first direction D1. The boot protrusion 66 protrudes from the outer peripheral surface of the boot 6 at a position away from the hook portion 612, thereby providing the identification portion 65 that is more easily visible.

The direction from the axis AX to the opening 5a is the same as the direction from the axis AX to the latch 42. The direction of the connector 1 for confirming the connection between the latch 42 and the adapter is the same as the direction of the connector 1 for confirming the engagement between the hook portion 612 and the protrusion 45. Thus, the connection and the engagement are easily performed.

The connector 1 is an LC connector including the plurality of ferrules 21 each holding an optical fiber.

Next, a modification of the connector according to the present disclosure will be described. A part of the configuration of the connector according to the modification described later is the same as a part of the configuration of the connector 1 described above. Thus, in the following, the same reference signs are given to the same components as those of the connector 1, and the description thereof will be omitted as appropriate.

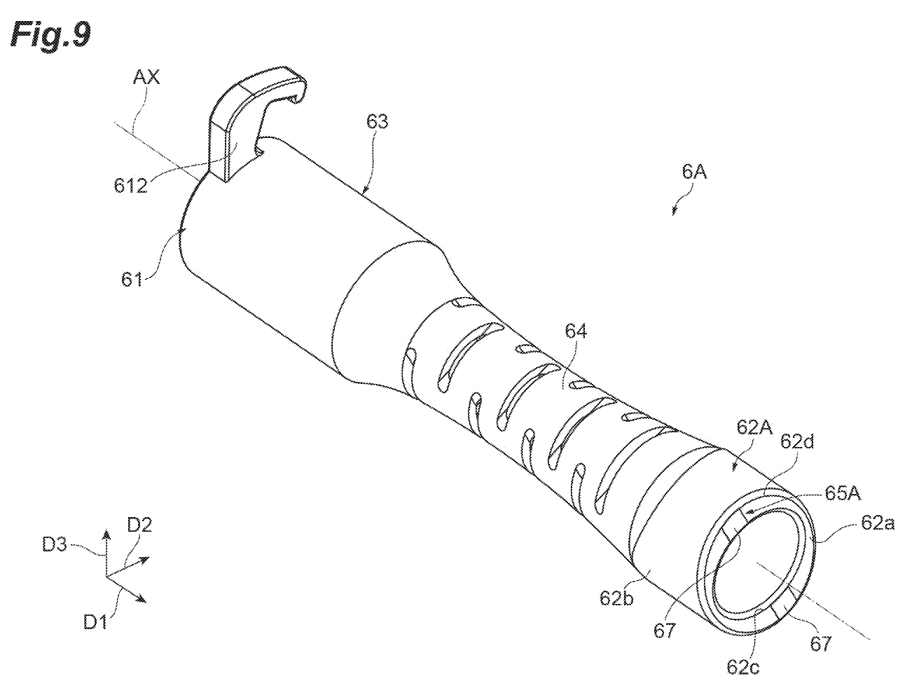

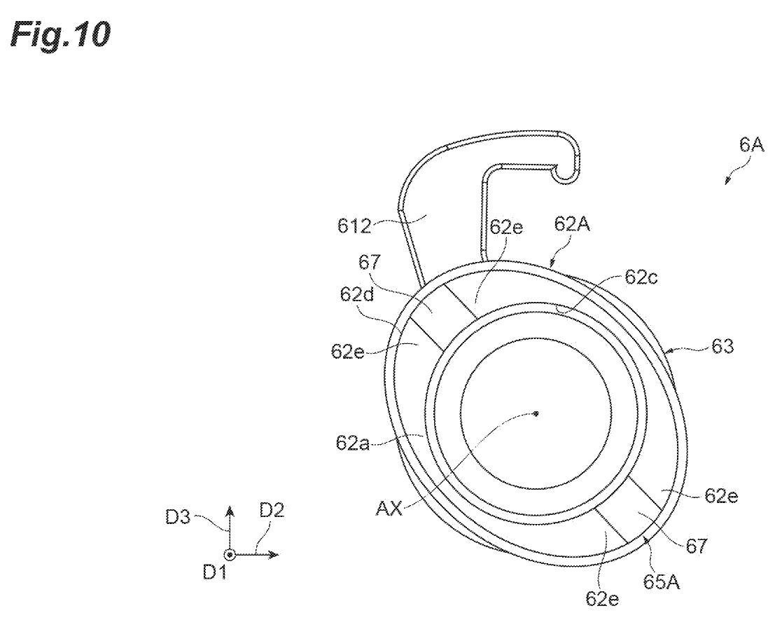

The connector according to the modification includes a boot 6A different from the boot 6. The boot 6A will be described with reference to FIGS. 9 and 10. FIG. 9 is a perspective view illustrating the boot 6A according to the modification. FIG. 10 is a rear view illustrating the boot 6A according to the modification. The boot 6A has a rear end portion 62A and an identification portion 65A.

The rear end portion 62A has a tubular shape. The rear end portion 62A includes a rear end surface 62a located at the rear end of the boot 6A and an outer peripheral surface 62b extending frontward from the rear end surface 62a. The rear end surface 62a includes an inner edge 62c and an outer edge 62d. The inner edge 62c forms a through hole into which an optical fiber is inserted. The inner edge 62c has, for example, a circular shape. The outer edge 62d is located at the boundary between the rear end surface 62a and the outer peripheral surface 62b. The outer edge 62d has, for example, an elliptical shape. However, the outer edge 62d may be a circular shape.

The identification portion 65A is a marker 67. The marker 67 is located at a position away from the hook portion 612 in the first direction D1. The marker 67 is provided on the outer surface of the rear end portion 62A. The marker 67 is provided on the rear end surface 62a. A plurality of (for example, two) markers 67 are provided on the rear end surface 62a. The two markers 67 are arranged, for example, so as to sandwich the axis AX. The two markers 67 are arranged along the long axis of the rear end surface 62a, for example. The rear end surface 62a includes a portion 62e adjacent to the marker 67. The color of the marker 67 is different from the color of the portion 62e. As an example, the boundary between the marker 67 and the portion 62e is linear. The marker 67 is located on the same plane as the portion 62e, for example. The marker 67 extends from the inner edge 62c to the outer edge 62d.

As described above, in the connector according to the modification, the identification portion 65A is the marker 67 located on the outer surface of the boot 6A at a portion away from the hook portion 612 in the first direction D1. The color of the marker 67 is different from the color of the portion 62e adjacent to the marker 67 on the outer surface of the boot 6A. In this case, the color of the marker 67 on the outer surface of the boot 6A is different from the color of the portion 62e adjacent to the marker 67, so that the identification portion 65A can be more easily visually recognized.

The embodiment of the connector according to the present disclosure has been described above. However, the connector according to the present disclosure is not limited to the contents of the above-described embodiment, and may be further modified within the scope of the gist described in the claims. That is, the shape, size, material, number, and arrangement of the respective parts of the connector according to the present disclosure can be appropriately changed within the scope of the above gist.

For example, in the above-described example, the connection portion 53 connects the second side wall 523 to the cover portion 51. However, the connection portion 53 may connect the first side wall 522 to the cover portion 51. The first portion 613, the second portion 614, and the third portion 615 of the hook portion 612 may be arranged along the second rotational direction R2.

In the example described above, the example in which the cut-out 52b is formed in the second side wall 523 has been described. However, the cut-out 52b may be formed in the first side wall 522.

In the modification described above, an example in which the boundary between the marker 67 and the portion 62e is linear has been described. However, the boundary between the marker 67 and the portion 62e may be curved. In the modification described above, an example in which the marker 67 is located on the same plane as the portion 62e has been described. However, the marker 67 may be a projecting portion that protrudes with respect to the portion 62e, or may be a recessed portion that is recessed with respect to the portion 62e.

In the modification described above, an example in which the marker 67 is provided on the rear end surface 62a has been described. However, the marker 67 may be provided in a portion other than the rear end surface 62a. The marker 67 may be provided on, for example, the outer peripheral surface 62b of the outer surface of the rear end portion 62A. The marker 67 may be provided in a portion other than the rear end portion 62A. The marker 67 may be provided on the outer surface of at least one of the front end portion 61, the connection portion 63, and the extending portion 64, for example.

In the above-described example, an example in which the identification portion 65 is the boot protrusion 66 and an example in which the identification portion 65A is the marker 67 have been described. However, the identification portion may be the elliptical outer edge 62d of the rear end portion 62A of the boot 6A. The identification portion may be a portion that is more conspicuous than the portion other than the identification portion of the boot, and may have, for example, a shape different from the portion other than the identification portion of the boot. In this manner, the form of the identification portion can be changed as appropriate.

What is claimed is:

1. A connector attachably and detachably connected to an adapter, the connector comprising:
a housing having a latch configured to be locked onto the adapter;
a tab connected to the housing and covering at least a portion of the latch; and
a boot rotatable with respect to the housing and configured to move with the tab, wherein
the tab is configured to release the latch from being locked onto the adapter by moving in a first direction in which the connector is detached from the adapter,
the housing includes a protrusion,
the boot has a hook portion engageable with the protrusion,
the tab is provided with an opening into which the protrusion and the hook portion are inserted,
the hook portion is configured to be engaged with the protrusion to enter into a locked state by the boot being rotated in a first rotational direction about an axis extending along the first direction with respect to the housing,
in the locked state, the boot is configured to be restricted from movement along the first direction with respect to the housing, and
the hook portion protrudes from the opening and is visible from a plurality of directions.

2. The connector according to claim 1, wherein
the hook portion is configured to be disengaged from the protrusion to enter into an unlocked state by the boot being rotated in a second rotational direction opposite to the first rotational direction with respect to the housing, and
in the unlocked state, the boot is movable along the first direction with respect to the housing.

3. The connector according to claim 1,
wherein the boot has an identification portion indicating a position of the hook portion.

4. The connector according to claim 3, wherein
the identification portion is a marker located on an outer surface of the boot at a position away from the hook portion in the first direction, and
the marker has a color different from a color of a portion of the outer surface of the boot adjacent to the marker.

5. The connector according to claim 3, wherein
the identification portion is a boot protrusion protruding from an outer peripheral surface of the boot at a portion away from the hook portion in the first direction.

6. The connector according to claim 1, wherein
a direction from the axis toward the opening is the same as a direction from the axis toward the latch.

7. The connector according to claim 1, wherein
the connector is an LC connector that further includes a plurality of ferrules, each of the plurality of ferrules holding an optical fiber.
